(19) United States
(12) Patent Application Publication
(10) Pub. No.: US 2025/0150713 A1
(43) Pub. Date: May 8, 2025

(54) CAMERA CONTROL

(71) Applicant: Mo-Sys Engineering Limited, London (GB)

(72) Inventor: Michael Paul Alexander Geissler, London (GB)

(73) Assignee: Mo-Sys Engineering Limited, London, OT (GB)

(21) Appl. No.: 18/838,156

(22) PCT Filed: Feb. 27, 2023
(86) PCT No.: PCT/GB2023/050435

§ 371 Date: Aug. 13, 2024

(30) Foreign Application Priority Data
Feb. 25, 2022 (GB) 2202671.0

(51) Int. Cl. H04N 23/695; H04N 5/262; H04N 23/611; H04N 23/661

(52) U.S. Cl. CPC H04N 23/695; H04N 5/2628; H04N 23/611; H04N 23/661

(57) ABSTRACT

A method for forming a processed video stream, comprising: capturing a first part of an input video stream using a camera and transmitting the first part of the video stream to a processing facility remote from the camera. At the processing facility, designating a first sub-region of the first part of the video stream for further processing. In dependence on the designation of a first sub-region. A first cropped video stream is formed by cropping the first part of the video stream to that sub-region. A processed video stream is formed incorporating the first cropped video stream.

This invention relates to remotely controlling a camera.

Cameras for capturing video from live events, such as sports events, are conventionally mounted on heads that allow the cameras to be tilted and panned. Tilting involves rotating the camera about a generally horizontal axis so that the camera's field of view is raised or lowered. Panning involves rotating the camera about a generally vertical axis so that the camera's field of view is moved from side to side. Such cameras are conventionally fitted with variable zoom lenses. By adjusting the zoom of the lens, the camera's field of view can be narrowed or widened. As an object of interest moves in front of the camera, it is desirable to control the camera's pan, tilt and zoom so as to capture the best view of the object. Normally, this is done by an operator located next to the camera.

A camera can be provided with a motorised head which allows its pan and tilt to be controlled remotely. Similarly, a camera may be provided with a motorised zoom lens, which allows the camera's zoom to be controlled remotely. In principle, equipment of this type could avoid the need for an operator at the camera's location. This could save significant travel cost when the camera is at a distant location from a filming company's base, and it could allow the camera to be positioned in locations (e.g. at a motor racing circuit) that are too dangerous for a person to occupy. With this in mind, an efficient way for a filming company to capture video of a live event at a remote location might be to ship a number of remotely controllable cameras to the location, to arrange for video feeds from that location to the company's central production facility, and for the cameras to be controlled remotely from the central facility. However, a problem with this arrangement can be that the time delay for signals between the central facility and the remote location is too long to allow the remote cameras to be controlled effectively. There is a first delay in the video feed being transmitted between the cameras and the production facility. Once an operator has viewed that feed and generated a control signal to a camera there is a second delay in that signal reaching the camera. If the camera is filming a fast-moving subject such as a downhill skier or a racing car, the total delay can result in a failure to react fast enough to movement of the subject, and the subject can be lost from the camera's field of view. This results in poor video footage. Also, once the subject has been lost from the camera's field of view if the camera is being controlled remotely it can be difficult for the camera operator to regain the subject because the operator is not able to see the subject directly.

There is a need for an improved way of controlling a camera remotely.

According to one aspect there is provided a method for forming a processed video stream, comprising: capturing a first part of an input video stream using a camera; storing the first part of the video stream at a first bandwidth; transmitting the first part of the video stream at a second bandwidth lower than the first bandwidth to a processing facility remote from the camera; at the processing facility, designating a first sub-region of the first part of the video stream for further processing; in dependence on the designation of a first sub-region, forming a first cropped video stream by cropping the stored first part of the video stream to that sub-region; forming the processed video stream incorporating the first cropped video stream.

The step of designating the first sub-region may be performed contemporaneously with the step of capturing the input video stream.

The processed video stream may be a live broadcast stream depicting a live event.

The step of capturing the input video stream may comprise capturing a video stream of a live event.

The camera may be adjustable to alter its field of view. The method may comprise in dependence on the designation of a first sub-region, forming a camera control signal; and adjusting the field of view of the camera in dependence on the camera control signal.

After the step of adjusting the field of view of the camera the following steps may be performed: capturing a second part of the input video stream using the camera; transmitting the second part of the input video stream to the processing facility; at the processing facility, designating a second sub-region of the second part of the input video stream for further processing; in dependence on the designation of a second sub-region: (i) forming a second cropped video stream by cropping the second part of the video stream to that sub-region; and forming the processed video stream incorporating the second cropped video stream.

The method may comprise transmitting the camera control signal to a camera installation comprising the camera; the camera installation being configured to automatically adjust the field of view of the camera in dependence on the camera control signal.

The step of forming the camera control signal may comprise automatically analysing the position and/or size of the first sub-region with respect to the entire field of the first part of the input video stream, and automatically applying a predetermined algorithm in dependence on that determination to form the camera control signal.

The camera control signal may be such as to cause the field of view of the camera to alter so as to bring a location in the first part of the input video stream at the centre of the first sub-region closer to the centre of the field of view of the camera.

The step of adjusting the camera may comprise adjusting the pan or tilt of the camera, or translating the camera. It may comprise rotating and/or translating the camera.

The camera control signal may be such as to cause the field of view of the camera to alter so as to bring a region in the first part of the input video stream of the size of the first sub-region closer in size to a predetermined target size.

The step of adjusting the camera may comprise adjusting the zoom of the camera.

The method may comprise: estimating the responsiveness of the camera to a previous camera control signal; and forming the camera control signal in dependence on that estimated responsiveness.

The step of designating a first sub-region of the first part of the video stream for further processing may be performed by a human designating the first sub-region, and the method may comprise displaying the boundary of the first sub-region to the user on a display.

The step of designating a first sub-region of the first part of the video stream for further processing may be performed by automatically analysing the first part of the video stream to identify a subject of interest therein, and designating the first sub-region so as to encompass that subject.

The processed video stream may have lower resolution than the input video stream.

According to a second aspect there is provided a method for forming a processed video stream, comprising: receiving a first part of an input video stream captured using a camera at a processing facility; at the processing facility, designating a first sub-region of the first part of the video stream for further processing; in dependence on the designation of a first sub-region: (i) forming a first cropped video stream by cropping the first part of the video stream to that sub-region and (ii) forming a camera control signal; forming the processed video stream incorporating the first cropped video stream; and transmitting the camera control signal to the camera for adjusting the field of view of the camera.

According to a third aspect there is provided the use, for the purpose of mitigating communication delay between the camera and the production facility, of a method as set out above.

According to a fourth aspect there is provided a video processing device comprising an input for receiving a captured video stream, a memory, and a controller configured to: store in the memory the captured video stream at a first bandwidth; compress the captured video stream to form a compressed video stream having a second bandwidth lower than the first bandwidth; transmit the compressed video stream in a form such that points in the progression of the compressed video stream are identifiable; receive a designation of a sub-frame region and an associated point in the progression of the compressed video stream; and form an output video stream by cropping the stored video stream to the designated region at a point in the stored video stream corresponding to the designated point.

The controller may be configured to form an output signal for controlling the direction and/or zoom of a camera in dependence on one or more of (i) the position of the designated sub-frame region relative to a whole frame and (ii) the size of the designated sub-frame region relative to a whole frame.

The controller may be configured to, during the period between the storing of a point in the video stream and the cropping of that point in the video stream perform video processing on that point in the video stream.

The video processing may comprise performing a process for improving the visual quality of that part of the video stream.

The controller and the camera may be configured so than in response to a command indicating the movement of a designated sub-region in a direction: (a) the controller moves in that direction the location of a sub-region selected for output and (b) the camera adjusts its field of view in that direction. Depending on how the sub-region is designated to the controller, one of those movements may be cancelled from the other.

The lower bandwidth video, and the higher bandwidth video may have common timestamps. When a command is sent to the controller it may be timestamped with the time of the lower bandwidth video to which it relates. Then the sub-region designated by that command may be selected in the higher bandwidth video at the corresponding timestamp.

The camera may have a powered head by which it can be panned and/or tilted. The camera may have a powered lens unit whose zoom can be adjusted.

The present invention will now be described by way of example with reference to the accompanying drawings. In the drawings:

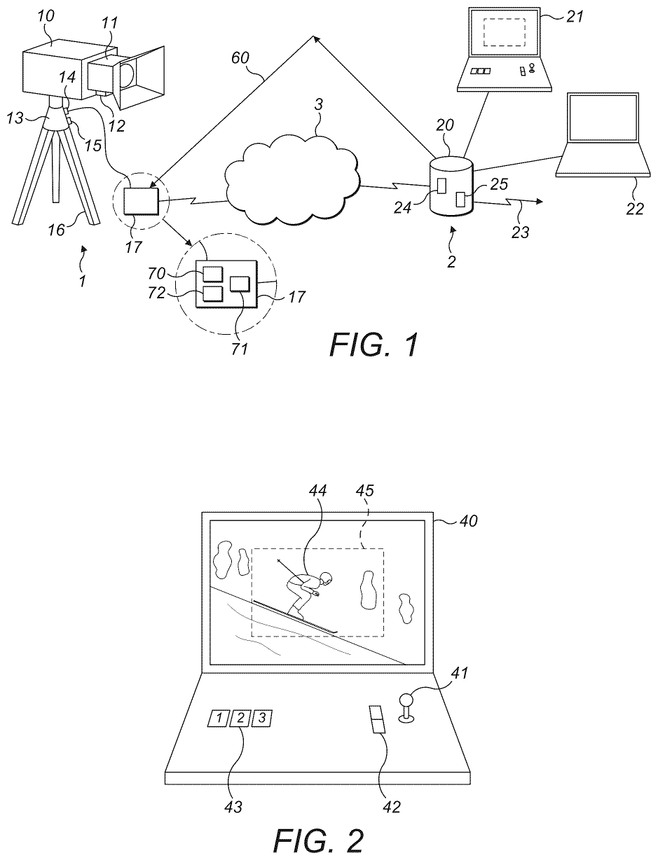

FIG. 1 shows a camera installation and a production facility.

FIG. 2 shows a control station.

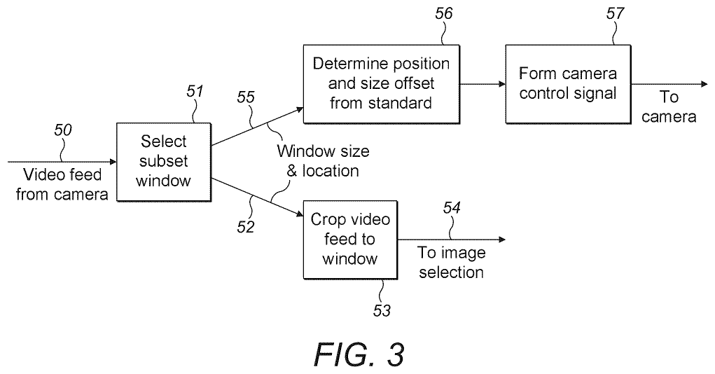

FIG. 3 illustrates a process for manipulating images and providing a camera control signal.

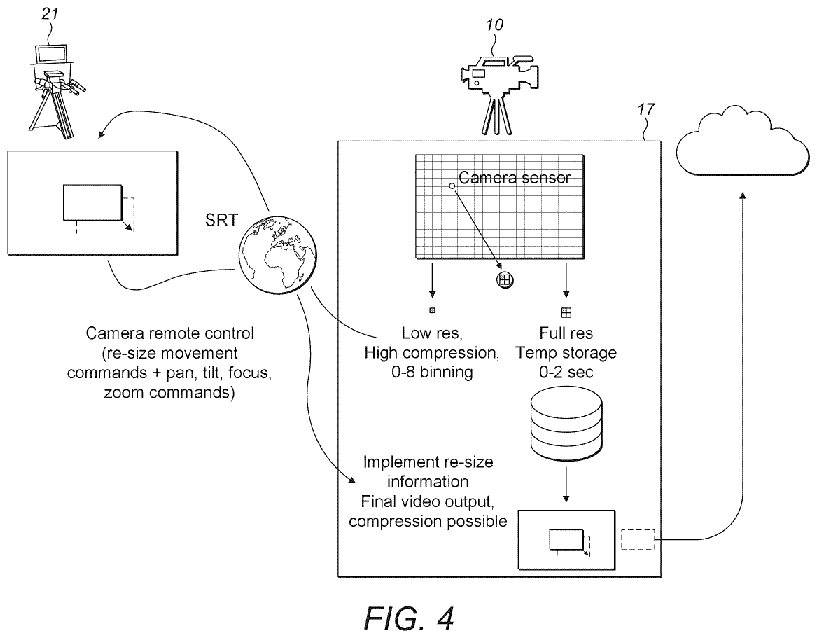

FIG. 4 shows a system for cropping an image under remote control.

FIG. 1 shows a camera installation indicated generally at 1 and a production facility shown generally at 2. The production facility is remote from the camera installation. The two are connected by a communications network shown at 3. That may be a publicly accessible network such as the internet. In practice, the camera installation may be at the site of a live event, such as a sports event, an arts performance or a news event. That may be taking place many miles or even thousands of miles from the production facility.

The camera installation comprises a camera 10. The camera is capable of capturing video. The camera has a variable zoom lens 11, which is provided with a motor 12 by which the zoom of the lens can be altered. The camera is mounted on a pan and tilt head 13. The pan and tilt head allows the direction in which the camera is pointing to be adjusted. The pan and tilt head is provided with motors 14, 15 for adjusting its pan and tilt. The camera could be mounted on motion devices of other types, for example a guide track, an articulated support arm or a drone. Such a motion device may be capable of translating the camera in one or more axes. For example, it may be capable of translating the camera in a first axis that is horizontal or has a horizontal component and/or a second axis that is vertical or has a vertical component. The first axis may be orthogonal to the second axis. In each case, the motion device is capable of adjusting the position of the camera and thereby adjust the camera's view. In each case, the motion device can be operated by one or more motors, linear actuators, hydraulic actuators, pneumatic actuators, propellers or the like to adjust the position of the camera. The camera is mounted on a tripod 16 or any other suitable mounting mechanism.

The camera is coupled by a communications cable or a wireless data link to a local camera controller 17. The local camera controller receives a video signal from the camera. The local camera controller comprises a buffer memory 70, a video processor 71 and a program memory 72. The buffer memory stores video data received from the camera. The video processor executes code to process the video data. The program memory stores in non-transient form the code that can be executed by the video processor. The video processor also controls the transmission of video data to the production facility. Video data from the camera is received by the camera controller at a certain resolution. That will be referred to below as full resolution. In full resolution there may be data representing the capture of each pixel of an image sensor of the camera, or the full resolution data may be compressed somewhat from the raw data captured by the camera. One function the video processor can perform is to compress the captured video data. Compression of the video data results in a video stream representing the same scene but at reduced bandwidth. That may, for example, be as a result of culling pixels, combining multiple pixels into tiles representing a larger part of the image or applying an algorithm that represents similar parts of an image using the same data. The reduced bandwidth representation of the full resolution video stream will be referred to as a compressed stream. The full resolution stream, or a high-resolution stream that is close to full resolution, is stored in buffer memory 70. In one mode of operation the video processor causes the full/high resolution stream to be transmitted to the production facility 2. In another mode of operation the video processor instead causes the compressed stream to be transmitted to the production facility 2. The camera controller also receives from the production facility movement control signals for controlling the movement of the camera and zoom signals for controlling the zoom of the camera and it transmits those signals to the appropriate motors or other motion units to control the operation of the camera. The local camera controller acts as a communications interface between the network 3 and the camera. The local camera controller is coupled to network 2 by a cable (e.g. an ethernet cable) or a wireless link (e.g. a cellular data link). The camera controller could be integrated with the camera or could be a separate unit.

The production facility 2 comprises a production control unit 20, an image subset control terminal 21 and a production control terminal 22. The production control unit manages the video feeds received from the camera 10 and potentially other cameras and generates control signal to the camera(s). The image subset control terminal 21 allows a user to select a portion of an image received from a camera. The production terminal 22 allows a user to combine video feeds received from multiple cameras, computer-generated sources and stored video data to form a video output stream at 23.

The production control unit is coupled to the network 3 for receiving video from camera 10 and potentially also from other cameras. The production control unit comprises a processor 24 and a memory 25. The memory stores in non-transient form program code executable by the processor to cause it to perform the functions of the production control unit as described herein. The production control unit is also coupled to the terminals 21, 22.

The image subset control terminal 21 is shown in more detail in FIG. 2. It comprises a display 40, a position user interface input 41, a zoom user interface input 42 and a camera selection user interface input 43.

An important function of the terminal 21 is to allow a user of the terminal to select a sub-region of a video stream generated by a camera. The camera may generate a video stream at a higher resolution than is required for the output stream at 23. Thus the number of pixels in the height and/or the width of the image captured by the camera may be more than the number of pixels in the respective dimension of the image as conveyed in the output stream. As an example, the camera may generate video at 4K resolution (3840×2160 pixels or 4096×2160 pixels) whereas the resolution required for the output stream may be 1080i resolution (1920×1080 pixels). To form the output stream, video from the camera may be downscaled and/or cropped. In one example, the entire field of view of the camera's video stream may be downscaled to the output resolution. In another example, a portion of the camera's video stream that has the same resolution as the output stream may be cropped from the camera stream. In another example a portion of the camera's video stream that is smaller than the entire field of view of the camera's video stream but greater than the output video stream may be both cropped from the camera stream and downscaled.

FIG. 2 shows the terminal 21 displaying a frame of a video stream received from a camera. The video stream is transmitted to the controller 20, as described above, and from the controller to the terminal 21. The camera video stream includes a subject 44, which in this case is a skier. The display 40 of the terminal 21 shows a boundary box 45. The boundary box 45 delineates the sub-region of the camera video stream that is to be selected for potential inclusion in the output video stream. The boundary box has the same proportions, e.g. pixel height to width ratio, as the output stream. A user of the terminal can change the size of the boundary box, by scaling it larger or smaller relative to the boundary of the camera stream, using the zoom input 42. The user can change the position of the boundary box, by moving it left, right, up or down relative to the boundary of the camera stream, using the position input 41. In this way the user can select a sub-region of the camera stream by delineating it with the boundary box. The portion of the camera image within the boundary box is considered to be selected.

In FIG. 2 the boundary box is indicated by an outline. The region designated by the boundary could be indicated in other ways, for example by a highlighted region of the display (e.g. as a region having greater brightness or contrast than the remainder of the display, or having a coloured cast).

Once a user of terminal 21 has designated a boundary box for the time being on a video stream from a camera, the terminal 21 transmits the size and location of that boundary box to the control unit 20. This may conveniently be done by transmitting the pixel locations of two opposite corners of the boundary box in the camera stream, or in any other suitable way. The control unit 20 then processes that camera stream to downscale and/or crop it to form an intermediate video stream that represents only that portion of the camera stream that is bounded by the boundary box, and has the resolution of the intended output stream. For example, if the camera stream has a resolution of 4096×2160 and the output stream has a resolution of 1920×1080 and the pixel locations relative to the camera stream of two opposite corners of the currently designated boundary box are [400,900] and [2511,2087] then the control unit 20 forms the intermediate stream by cropping the camera stream to the rectangular 2112×1188 window having [400,900] as one corner, and then downscaling that rectangle to 1920×1080. It is possible for the selected rectangle to be upscaled rather than downscaled, although that would result in an output image of reduced quality. That intermediate image may form the output stream. Alternatively, the output stream may be formed from one or more selected intermediate streams, as described below.

In practice, there may be multiple cameras at a filming location, and their streams together with other video feeds such as computer generated imagery and overlays may need to be combined and alternated to form the output video stream. When there are multiple cameras 10 at a remote location, there may conveniently be one terminal 21 for each such camera. Then the boundary of the desired region of video can be conveniently designated in real time for each camera, and a respective intermediate stream formed accordingly. Alternatively, one terminal could be used to designate the regions of interest for multiple streams simultaneously. The region of interest for a stream could be designated manually, as described above, or automatically by image recognition software which could be configured to designate a region having predetermined characteristics such as relatively high contrast or an appearance that resembles a predetermined object such as a person.

Terminal 22 provides a user interface which receives the available video (preferably the intermediate streams) and other inputs, and allows a user to select which ones are to be used to form the output image. For example, terminal 22 allows a user to switch between different camera or intermediate feeds as a subject moves from the field of view of one camera to another. The controller 20 provides the available video (preferably the intermediate streams) and other inputs to the terminal 22. A user of terminal 22 indicates by means of a user input device (e.g. a keyboard, touchscreen or pointing device) at the terminal 22 which one(s) of the available content is/are to form the output stream. That indication is sent to the control unit 21. The control unit 21 then forms the output stream at 23 by selecting the appropriate content.

One or both of the terminals 21, 22 may be implemented automatically, using an algorithm to select a desired portion of a video stream, or to select a desired content stream. In that case the terminals may be integrated with the controller 20.

Thus, in a first mode of operation, a video stream is transmitted from the region of the camera to the production facility which may be remote from the camera. At the production facility a region of that video stream can be selected for further transmission or storage, and in response to where that region is relative to the boundary of the video stream the camera can be controlled automatically to pan so as to bring the subject in that region closer to the centre of the captured frame.

FIG. 3 shows some of the process steps in forming the output image using this mode of operation. The video feed from a camera is received at 50 and passed to an image subset selection terminal 21. At the terminal 21 a desired portion of the video stream is selected. (Step 51). This step may be done manually or automatically. The terminal 21 transmits the location and size of the boundary box to the controller 20. (Step 52). The controller crops and/or downscales the selected portion of the camera stream to form an intermediate stream at the intended output resolution. (Step 53). That can then be passed to terminal 22 (step 44) to select a stream for incorporation into the output stream. In practice there may be multiple output streams, showing respective parts of a race, respective participants, respective points of view and so on.

The size and location of the boundary box is an indication of the portion of the camera stream that is most of interest. In the present system, that information is used to cause motion and/or zooming of the camera. This can avoid the need for separate control of the camera, and can have the result that the camera is automatically kept keyed to the portion of interest. It can do this in a manner that mitigates delay between the camera and the location from which it is controlled. The mechanism for this will now be described.

As indicated in FIG. 3, the size and location of the boundary box or window is passed (step 55) as input to a step (56) of determining the deviation of that size and location from a predetermined standard. In dependence on that deviation, control signals for movement (e.g. pan and tilt, or movement of an arm or a camera dolly) and/or zoom are formed. (Step 57). Steps 56 and 57 may be performed at the controller 20. Then those control signals are transmitted to the interface 17, and used to control the motion and/or zoom of the camera. The signals may be sent towards the camera over the same link as is used to send the video from the camera, or over a different link 60. Either link may, independently, pas via or not pass via the network 3. Thus, the movement and/or zoom of the camera are controlled remotely in response to the selection of a portion of the video stream from the camera that is designated for further processing. This can avoid the need to separately select a portion of the captured video stream that is of interest and control the camera. When the camera control signal is generated so as to tend to keep the locations corresponding to the designated region spaced from the edge of the captured video stream, this can mitigate against transmission delays between the camera and the location where the video is analysed, since even in the event of a delay in the movement of the camera, there can be freedom to move or zoom the designated region beyond its current position.

Some examples of how the camera can be controlled in response to movement of the boundary box will now be described.
1. The centre of the boundary box may be determined. If that centre is above a predetermined point in the camera mage frame, conveniently the centre of the camera image, frame then the camera may be signalled to tilt up or to move up. If the boundary box centre is below the centre of the camera image then the camera may be signalled to tilt down or to move down. If the boundary box centre is left of the centre of the camera image then the camera may be signalled to pan left or to move left. If the boundary box centre is right of the centre of the camera image then the camera may be signalled to pan right or to move right. In each case the centre may be the geometric centre, i.e. the point of intersection of the diagonals of the box or image frame. Thus, the camera may be controlled so that its field of view moves to tend to bring the location in the camera's field of view that is at the centre of the boundary box closer to the centre of the camera's field of view. The rate of movement of the camera's field of view may be dependent on the distance of the centre of the boundary box from the centre of the camera's field of view. The rate of movement may be controlled to be faster as that distance increases.
2. A predetermined preferred size for the boundary box may be determined. That may be expressed as a proportion of the size of the camera image frame. The proportion may, for example, be 60%. The proportion is preferably between 80% and 50%. If the proportion is too large then the tolerance for delay in camera control may be too small. If the proportion is too small then the boundary box may from time to time need to be so small that the output image is being upscaled, which can reduce output quality. If the boundary box is larger than the preferred size then the camera may be caused to zoom out. If the boundary box is smaller than the preferred size then the camera may be caused to zoom in. Thus the camera may be controlled so that its field of view scales to tend to bring the size of the boundary box to the predetermined preferred size. The rate of zoom may be dependent on the difference between the boundary box size and the preferred size. The rate of zoom may be controlled to be faster when that difference is greater.

Put another way, a camera captures a video stream at a first resolution. That video stream is transmitted to a control location. The control location may be remote from the camera. As a result, there may be substantial delays for signals (i) conveying video from the camera to the control location and/or (ii) conveying control signals from the control location to the camera. The camera is configured so that its field of view can be adjusted in dependence on signals received from the control location. This may involve one or more of (i) rotating the camera (e.g. in pan or tilt), (ii) adjusting the zoom of the camera and (iii) translating the camera, e.g. on a track, an articulated arm or a drone. At the control location a sub-region of the video stream captured by the camera is designated. That designation may be done manually or automatically. The video stream captured by the camera may be displayed at the control centre contemporaneously with its being received at the control centre on a terminal that comprises a user interface whereby a user of the terminal can designate a region of the displayed video. The user interface may permit the designated region to be (i) moved vertically and/or horizontally with respect to the captured video and/or (ii) changed in size with respect to the full frame size of the captured video. In response to the designation of a region of the video, two operations may be performed.
1. A secondary video stream may be formed by cropping the video stream from the camera to the designated region. That secondary video stream may be output for viewing elsewhere.
2. A control signal may be formed in dependence on the size and/or location of the designated region with respect to the full frame of the video. That control signal is then transmitted to the camera to control it. The control signal is formed such that it will cause the camera's field of view to move in such a way as to bring the subject location that occupies the designated region (i) closer to the centre of the camera's field of view and/or (ii) closer to being of a predetermined size in the camera's field of view.

Together, these steps can permit the camera to be controlled automatically with a reduced perception of lag at the control location compared to a system in which an operator there is not able to select a sub-region of the captured video. They can also permit the camera's field of view to be controlled in a way that makes it easier for an operator to maintain a subject in the camera's field of view.

When the designated region is being designated by an operator, the operator's control station may show the entire field of view of the captured video, and highlight the region designated by the operator. Alternatively it may shows just the region designated by the operator. The second approach can be beneficial in that it can give the operator the sensation that he is controlling the camera with minimal lag. This happens because short-term adjustments made by the operator can be accommodated by adjusting the sub-region of the captured video that is designated, whereas longer-term adjustments can be accommodated by motion of the camera. The system can thus be considered as operating with two feedback loops, one inside the other.

When the camera's field of view moves or changes size, it may be desirable to automatically adjust the designated region in the opposite sense. This can reduce the likelihood of the operator feeling that the system has overreacted to a control input.

With these approaches, the camera can tend to follow a guide given by the location and size of the boundary box, so as to concentrate on the area of the image that is of greatest interest.

The camera control signal may be generated automatically and/or algorithmically by the processor 24. The camera control signal may be generated by a computer configured to generate the signal in accordance with pre-stored instructions to implement an algorithm whereby the signal is formed in dependence on the location and/or size of the boundary box relative to the video stream captured by the camera. The camera control signal may be generated periodically. It may be generated for each frame of the image, or each time the boundary box moves, or at predetermined intervals, e.g. every 5 ms or 10 ms.

The nature of the camera control signal will depend on the interface 17 and the motors or other devices used to control the camera. In respect of each of the camera's pan, tilt, position and/or zoom it may, for example, indicate a target state or a commanded movement.

The responsiveness of the camera may be varied to take account of the signalling delay between the camera 1 and the control station 2. The rate or magnitude of camera adjustment may be varied depending on that signalling delay. This can help to avoid the camera reacting too quickly or slowly to movement or re-sizing of the boundary box. In one example, the control station has access to a measurement of the signalling delay between the camera installation and the control unit 20. This measurement may be made by the control station, or by the camera installation and then signalled to the control unit. The timing measurement may be made by any known measurement technique: for example both ends of the data link could synchronise to a common clock and then the time of signal propagation could be measured with reference to that clock. Once the delay is known, the rate of camera adjustment in response to a given deviation of the box centre or size from a reference point or size may be adjusted in dependence on the delay. For larger delays, the rate of adjustment may be greater. In an alternative approach, a preferred rate of adjustment may be learned automatically by treating an increased frequency of reversals in motion or sizing of the boundary box as indicative of an overshoot in the camera's movement. The frequency of reversal in motion (up to down or left to right) or sizing (increase to decrease or vice versa) of the boundary box may be detected over a period of time, e.g. 10s or 30s. When that frequency is greater than a first predetermined value, the responsiveness of the camera may be reduced, e.g. by adapting the control signals to command a lower rate or magnitude of adjustment. When that frequency is less than a second predetermined value (which is less than the first predetermined value), the responsiveness of the camera may be reduced, by adapting the control signals to command a greater rate or magnitude of adjustment. The camera control signals may be formed such that the rate of change of the camera's field of view is dependent on the deviation of the designated region from a predetermined location (typically this would be centred with respect to the captured video stream) and/or size. As the designated region deviates further from that predetermined location and/or size the rate of change is increased. This can help an operator to maintain a subject in the camera's field of view. Thus, the responsiveness of the control mechanism may be tuned automatically to the level of delay over the link. Other control loop mechanisms may be used to tune responsiveness over the link.

The units 20, 21, 22 may be combined together in any suitable fashion or split up into multiple physical devices such as terminals and computer servers.

In the examples given above, the camera is physically moved in response to the selection of a different region in the video stream. In another system, the transmission of relatively high resolution video from a camera may be used to give an operator at a location remote from the camera the sensation that he is in fact moving the camera. The camera captures video at a resolution greater than an intended output resolution. That video is transmitted from the camera to a location remote from the camera. The operator is at that location. The operator is provided with a user interface device that simulates a camera. It may, for example be set on a pan/tilt head. It may have handles or other apparatus of a physical type that is conventionally used to move a camera. One example is a pan bar. It may have a zoom control of the physical type that is conventionally used to zoom a camera, for example a twist grip, slider or rocker on a pan/tilt handle. The user interface device has a video display. It may be a video display which is configured to simulate a type conventionally used as part of a camera to permit an operator to view the image that the camera is capturing. Put another way, the operator is provided with a simulated camera. Sensors are provided for sensing the position of the various user inputs. A processing device, which could be incorporated in the simulated camera or could be a separate unit, selects a portion of the video stream received from the remote camera in dependence on the sensed position of the user inputs, and causes that portion to be displayed on the video screen of the operator's device. That portion may also be passed for further processing, as described in more detail above. The processing device selects the portion in such a way as to give the operator the sensation that he is operating a real camera. Thus, if the direction in which the operator's device is directed moved by a given angle in a given direction, the portion selected is moved as if a remote camera had moved by the same angle in the same direction. If the zoom control of the operator's device is altered as if to zoom a camera by a certain amount in our out then the portion selected is zoomed in or out by that amount. This gives the user the sensation that he is operating an actual camera. This can make the selection of a portion of video captured by the remote camera a more intuitive operation for a trained camera operator. Optionally the remote camera may be moved in response to the movement of the selected portion in the manner described in more detail above.

In the examples discussed above, the entire area (full frame) of the captured video stream might typically be transmitted to the production facility, and the reduction of that stream to the selected region (part frame) performed at the production facility. A second mode of operation will now be described.

In one example of the second mode of operation, the reduction of the video stream to the selected region (part frame) is performed proximate to the camera, e.g. at the camera controller. By proximate to the camera is meant a location sufficiently convenient to the camera that the full resolution video stream captured by the camera can readily be transmitted there. The full resolution video stream, or a high-resolution representation of it is buffered. It may be buffered in memory 70. A lower resolution version of the full frame video stream is transmitted to the production facility. The lower resolution version is lower resolution and/or of lower bandwidth than the stream that is buffered. At the production facility an operator or an automated system selects a sub-region of the stream from time to time. That may be done as described above, by moving the region in the full frame (analogous to panning and tilting) and altering the size of the region (analogous to zoom adjustment). Information defining the location and size of the selected region is transmitted to the camera controller 17. The information indicates a timestamp for the part of the video stream in which the indicated region was selected. That may be done by indicating a timestamp, frame number or other such reference in the stream transmitted to the production facility and including the same reference, or a reference that can be correlated with it, in the information returned to the camera controller that being a reference to a part of the video stream being played or processed at the production facility when the region was selected. In response to that information the camera controller:
(i) Selects the designated sub-frame region in a portion of the buffered video stream at the designated timepoint, and outputs that as an output stream, for example for playout to viewers.
(ii) Commands the camera using the logic described above so as to move the subject of the selected region closer to the centre of the captured video stream and/or to adjust the camera's zoom so that the selected region occupies a predetermined proportion of the full frame of the captured video stream (e.g. 30% of the area of the full frame). With this system, there is no need to transmit a high-resolution video stream to the production facility. That can reduce delays and cost.

Due to delays in transmitting the stream to the production facility and receiving commands from the production facility the high-resolution stream will typically be buffered at the camera controller for some time, e.g. a few seconds. During that time the camera controller can usefully perform post-processing on the buffered stream, e.g. to improve its visual quality. Examples of such operations include sharpening, noise reduction, blur reduction, colour balancing and gamut adjustment. By performing that processing on a part of the captured video stream before a command is received as to which region of that part of the stream is to be selected, the time at which a suitably post-processed version of the stream can be output is reduced. Once a part of the captured video stream has been output for viewing or storage the corresponding data in buffer 70 can be deleted, freeing up memory.

FIG. 4 shows a system for performing this series of operations. Like components are designated as in FIG. 1. At a videography site a camera 10 is provided with physical actuators (e.g. motors or linear actuators) or software settings for adjusting one or more of its pan, tilt, zoom, frame rate, sensitivity or any other video capture parameter. An automated production facility 17 is local to the camera 10. It could be adjacent the camera 10 or otherwise sufficiently close to camera 10 that data can readily be exchanged between the two at a suitably high bandwidth. High resolution video data from the full frame of the camera's optical sensor is cached in a temporary store at the production facility. The temporary store may, for example, cache two seconds of full frame data. Meanwhile a compressed version of the captured data is transmitted to a control facility remote from the camera. The compressed data may be of lower resolution than the data stored in the cache. The compressed data or part of it is played out at the control facility to an operator. The operator may operate a simulated camera device 21 which simulates what a camera operator would see if the camera 10 were controlled as the simulated camera device is controlled. A sub-region of the full frame as captured by camera 10 is displayed to the user of device 21. Alternatively the whole of the full frame may be displayed overlain by a bounding box that designates a sub-region of the frame. That sub-region designates a region selected for output.

A user of the control facility selects a sub-region of the full frame captured by the camera. The user selects the size of the sub-region, which corresponds to zoom, and the location of the sub-region on the full frame, which corresponds to pan and tilt.

The operation of the production facility 17 and the camera 10 is dependent on input transmitted from the control facility in dependence on the size and location of the selected sub-region for a given frame of or time location in the video. The size and location may vary from frame to frame or from time to time. There will be a lag in commands dependent on the size and location of the sub-frame reaching the production facility 17 due to the time taken for the compressed video to be transmitted to the control centre and the commands to be returned. This is why the full frame full resolution video is buffered at the production facility. As time progresses, commands relating to a selected size/location and the frame/time to which that selection applies are received at the production facility. A processor at the production facility then selects a sub-part of the frame or other unit of video data stored in the cache for that frame/time. The selected sub-part is that designated by the user of the control facility, That sub-part is output as a frame of output video feed. The parts of the full frame surrounding that sub-part are discarded and not included in the output video feed. In this way, the output video feed corresponds to what is selected as the sub-frame at the control facility.

Furthermore, the zoom, pan and/or tilt of the camera may be adjusted in response to the size and/or position of the sub-frame in the full frame. The adjustment may be such as to draw the selected sub-frame closer to a predetermined size centred in the full frame. Thus, if the selected sub-frame is made larger the camera may zoom out, and vice versa. If the selected sub-frame is moved left in the full frame, the camera may pan left and vice versa. If the selected sub-frame is moved up in the full frame, the camera may tilt up and vice versa. This allows continued scope for the user at the control facility to zoom, pan or tilt further.

With a user interface at the control facility that mimics a camera, the user may have the sensation that they are operating a camera locally to them.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for forming a processed video stream, comprising:
capturing a first part of an input video stream using a camera;
storing the first part of the video stream at a first bandwidth;
transmitting the first part of the video stream at a second bandwidth lower than the first bandwidth to a processing facility remote from the camera;
at the processing facility, designating a first sub-region of the first part of the video stream for further processing;
in dependence on the designation of a first sub-region, forming a first cropped video stream by cropping the stored first part of the video stream to that sub-region;
forming the processed video stream incorporating the first cropped video stream.

2. A method as claimed in claim 1, wherein the step of designating the first sub-region is performed contemporaneously with the step of capturing the input video stream.

3. A method as claimed in claim 1 or 2, wherein the processed video stream is a live broadcast stream depicting a live event.

4. A method as claimed in any preceding claim, wherein the step of capturing the input video stream comprises capturing a video stream of a live event.

5. A method as claimed in any preceding claim, wherein the camera is adjustable to alter its field of view; and the method comprises in dependence on the designation of a first sub-region, forming a camera control signal; and
adjusting the field of view of the camera in dependence on the camera control signal.

6. A method as claimed in claim 5, comprising, after the step of adjusting the field of view of the camera:
capturing a second part of the input video stream using the camera;
transmitting the second part of the input video stream to the processing facility;
at the processing facility, designating a second sub-region of the second part of the input video stream for further processing;
in dependence on the designation of a second sub-region: (i) forming a second cropped video stream by cropping the second part of the video stream to that sub-region; and
forming the processed video stream incorporating the second cropped video stream.

7. A method as claimed in claim 5 or 6, comprising:
transmitting the camera control signal to a camera installation comprising the camera;
the camera installation being configured to automatically adjust the field of view of the camera in dependence on the camera control signal.

8. A method as claimed in any of claims 5 to 7, wherein the step of forming the camera control signal comprises automatically analysing the position and/or size of the first sub-region with respect to the entire field of the first part of the input video stream, and automatically applying a predetermined algorithm in dependence on that determination to form the camera control signal.

9. A method as claimed in any of claims 5 to 8, wherein the camera control signal is such as to cause the field of view of the camera to alter so as to bring a location in the first part of the input video stream at the centre of the first sub-region closer to the centre of the field of view of the camera.

10. A method as claimed in claim 9, wherein the step of adjusting the camera comprises adjusting the pan or tilt of the camera, or translating the camera.

11. A method as claimed in any preceding claim, wherein the camera control signal is such as to cause the field of view of the camera to alter so as to bring a region in the first part of the input video stream of the size of the first sub-region closer in size to a predetermined target size.

12. A method as claimed in claim 11, wherein the step of adjusting the camera comprises adjusting the zoom of the camera.

13. A method as claimed in of claims 5 to 12, comprising:
estimating the responsiveness of the camera to a previous camera control signal; and
forming the camera control signal in dependence on that estimated responsiveness.

14. A method as claimed in any preceding claim, wherein the step of designating a first sub-region of the first part of the video stream for further processing is performed by a human designating the first sub-region, and the method comprises displaying the boundary of the first sub-region to the user on a display.

15. A method as claimed in any of claims 1 to 13, wherein the step of designating a first sub-region of the first part of the video stream for further processing is performed by automatically analysing the first part of the video stream to identify a subject of interest therein, and designating the first sub-region so as to encompass that subject.

16. A method as claimed in any preceding claim, wherein the processed video stream has lower resolution than the input video stream.

17. A method for forming a processed video stream, comprising:
receiving a first part of an input video stream captured using a camera at a processing facility;
at the processing facility, designating a first sub-region of the first part of the video stream for further processing;
in dependence on the designation of a first sub-region: (i) forming a first cropped video stream by cropping the first part of the video stream to that sub-region and (ii) forming a camera control signal;
forming the processed video stream incorporating the first cropped video stream; and
transmitting the camera control signal to the camera for adjusting the field of view of the camera.

18. Use, for the purpose of mitigating communication delay between the camera and the production facility, of a method as claimed in any preceding claim.

19. A video processing device comprising an input for receiving a captured video stream, a memory, and a controller configured to:
store in the memory the captured video stream at a first bandwidth;
compress the captured video stream to form a compressed video stream having a second bandwidth lower than the first bandwidth;
transmit the compressed video stream in a form such that points in the progression of the compressed video stream are identifiable;
receive a designation of a sub-frame region and an associated point in the progression of the compressed video stream; and
form an output video stream by cropping the stored video stream to the designated region at a point in the stored video stream corresponding to the designated point.

20. A video processing device as claimed in claim 19, wherein the controller is configured to form an output signal for controlling the direction and/or zoom of a camera in dependence on one or more of (i) the position of the designated sub-frame region relative to a whole frame and (ii) the size of the designated sub-frame region relative to a whole frame.

21. A video processing device as claimed in claim 19 or 20, wherein the controller is configured to, during the period between the storing of a point in the video stream and the cropping of that point in the video stream perform video processing on that point in the video stream.

22. A video processing device as claimed in claim 21, wherein the video processing comprises performing a process for improving the visual quality of that part of the video stream.
